(19) United States
(12) Patent Application Publication
(10) Pub. No.: US 2015/0019052 A1
(43) Pub. Date: Jan. 15, 2015

(54) TRANSMISSION CONTROL DEVICE AND TRANSMISSION CONTROL METHOD

(71) Applicants: Takaya Katsuragi, Tokyo (JP); Satoru Takahashi, Tokyo (JP); Yuji Hamada, Tokyo (JP)

(72) Inventors: Takaya Katsuragi, Tokyo (JP); Satoru Takahashi, Tokyo (JP); Yuji Hamada, Tokyo (JP)

(73) Assignee: Mitsubishi Electric Corporation, Chiyoda-ku, Tokyo (JP)

(21) Appl. No.: 14/373,211

(22) PCT Filed: Oct. 23, 2012
(86) PCT No.: PCT/JP2012/077294

§ 371 Date: Jul. 18, 2014

(30) Foreign Application Priority Data
Jan. 20, 2012 (JP) 2012-009923

(51) Int. Cl. B61L 15/00; H04L 12/40

(52) U.S. Cl. CPC B61L 15/0018; H04L 12/40143; B61L 15/0072
USPC 701/19

(57) ABSTRACT

A train state retriever acquires the state of a train. Based on the state of the train, a transmission priority determiner determines a transmission priority in transmitting transmission data serving as a transmission object to a transmission path. A transmitter transmits the transmission data to the transmission path in accordance with the determined transmission priority.

### TECHNICAL FIELD

The present invention relates to a transmission control device and a transmission control method for controlling transmission by using the state of a train.

### BACKGROUND ART

A railroad vehicle is provided with an on-vehicle network by which information necessary for a control of vehicle apparatuses is periodically transmitted via a single line. Transmitting a large amount of information at one time causes a transmission failure due to a delay in transmission or a collision of information, which impairs real-time properties in transmitting information. This results in a problem that responsiveness necessary for the control of vehicle apparatuses cannot be ensured.

As a countermeasure to the problem, Patent Document 1 discloses an information transmission system in which transmission information is classified into media information such as advertisements and control information, and each of the information is given data indicating a transmission order. A switching hub provided in the on-vehicle network refers to the data indicating the transmission order that has been set for information flowing on the on-vehicle network, and transmits the information in the sequence from information having an earlier transmission order. Hereinafter, a technique disclosed in the Patent Document 1 will be also called Relevant Technique A.

Here, the transmission order for the control information is set earlier than the transmission order for the media information. This makes the switching hub transmit the control information earlier than the media information. Thus, the real-time properties in transmitting the control information are not impaired even when both the control information and the media information exist on a transmission path. Hereinafter, information that is a transmission object will be also called transmission information.

### PRIOR-ART DOCUMENTS

### Patent Documents

Patent Document 1: Japanese Patent No. 4227556

### SUMMARY OF THE INVENTION

### Problems to be Solved by the Invention

In a train, the type of transmission information that should be preferentially transmitted varies depending on the state of the train. In a case where the transmission order set for transmission information is static (Fixed) irrespective of the type of the transmission information as shown in the Relevant Technique A, a delay in transmitting the transmission information can be suppressed. In this case, however, the degree of priority of the transmission information, which varies depending on the state of the train, cannot be reflected into the transmission of the transmission information, and therefore a transmission control in accordance with the state of the train cannot be achieved.

The present invention is accomplished to solve the above-described problems, and an object of the present invention is to provide a transmission control device, or the like, that achieves a transmission control for controlling transmission of transmission data in accordance with the state of a train.

### Means for Solving the Problems

To attain the object, a transmission control device according to one aspect of the present invention is a transmission control device configured to transmit data within a train by using a transmission path provided in the train, the transmission control device including: a train state retriever that acquires the state of the train; a transmission priority determiner that determines a transmission priority based on the acquired state of the train, the transmission priority being the degree of priority of transmission of transmission data serving as a transmission object to the transmission path; and a transmitter that transmits the transmission data to the transmission path in accordance with the transmission priority determined.

### Effects of the Invention

In the present invention, the transmission priority determiner determines, based on the state of the train, the transmission priority in transmitting transmission data serving as a transmission object to the transmission path. The transmitter transmits the transmission data to the transmission path in accordance with the transmission priority determined.

This achieves a transmission control for controlling transmission of transmission data in accordance with the state of the train. Accordingly, a transmission control for controlling transmission of transmission data with a high accuracy is achieved.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 A block diagram showing a configuration of a train according to an embodiment 1.

FIG. 2 A block diagram showing a configuration of a transmission control device according to the embodiment 1.

FIG. 3 A flowchart showing a transmission control process.

FIG. 4 A diagram showing an example of a transmission priority database.

FIG. 5 A block diagram showing a configuration of a transmission control device according to a modification of the embodiment 1.

FIG. 6 A diagram showing an example of the transmission priority database.

FIG. 7 A block diagram showing a configuration of a transmission control device according to an embodiment 2.

FIG. 8 A diagram showing an example of the transmission priority database.

FIG. 9 A block diagram showing a configuration of a transmission control device according to an embodiment 3.

FIG. 10 A block diagram showing a configuration of a transmission control device according to an embodiment 4.

FIG. 11 A diagram showing an example of the transmission priority database.

FIG. 12 A block diagram showing a configuration of a transmission control device according to an embodiment 5.

FIG. 13 A diagram showing an example of the transmission priority database.

FIG. 14 A flowchart showing a transmission control process A.

### EMBODIMENT FOR CARRYING OUT THE INVENTION

Hereinafter, embodiments of the present invention will be described with reference to the drawings. In the following description, the same components are given the same reference signs. The name and function of the same component are also the same over the description herein. Therefore, detailed description thereof may be omitted.

### Embodiment 1

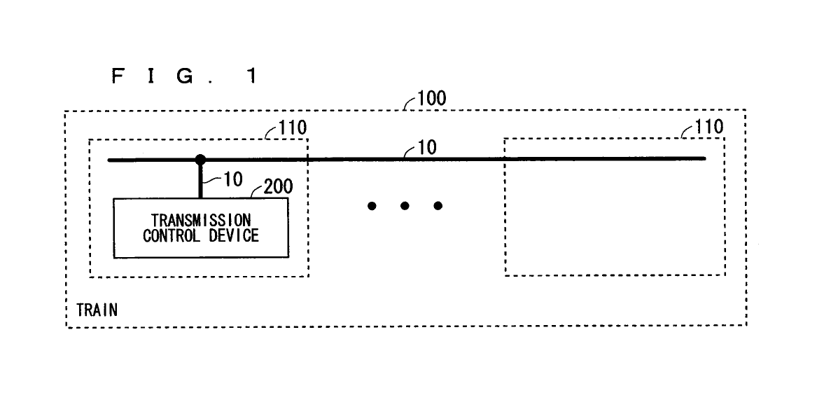

FIG. 1 is a block diagram showing a configuration of a train 100 according to an embodiment 1. Referring to FIG. 1, the train 100 includes a plurality of vehicles 110. The plurality of vehicles 110 is connected to a transmission path 10. Each vehicles110 is able to communicate to another vehicle 110 via the transmission path 10. The train 100 performs processing, and the like, in accordance with various types of data that are transmitted through the transmission path 10.

A transmission control device 200 is provided in each vehicle 110. The transmission control device 200 is connected to the transmission path 10. The transmission control device 200 is a device that controls transmission of data to the transmission path 10. The transmission control devices 200 transmit data in the train 100 by using the transmission path 10 provided in the train 100.

It is not necessary that the transmission control device 200 is provided in every vehicle 110 included in the train 100. For example, the transmission control device 200 may be provided in any ones of the plurality of vehicles 110.

FIG. 2 is a block diagram showing a configuration of the transmission control device 200 according to the embodiment 1. Referring to FIG. 2, the transmission control device 200 includes a train state retriever 210, a transmission priority database 220, a transmission priority determiner 230, and a transmitter 240.

The train state retriever 210 acquires the state of the train 100, though a detailed description thereof will be given later.

In this embodiment, the state of the train 100 is, for example, a state where the train 100 is traveling (moving) at a high speed of 50 Km/h or more. That is, the state of the train 100 is the state of traveling of the train 100, which is expressed by the speed of the train 100.

The transmission priority database 220 indicates various states of the train 100 in association with different transmission priorities, though a detailed description thereof will be given later. The transmission priority means the degree of priority of transmitting transmission data serving as a transmission object to be transmitted to the transmission path 10.

The transmission priority determiner 230 determines the transmission priority based on the acquired state of the train 100, though a detailed description thereof will be given later.

The transmitter 240 transmits the transmission data to the transmission path 10 in accordance with the transmission priority determined by the transmission priority determiner 230. To be specific, the transmitter 240 changes the cycle of transmission of the transmission data in accordance with the transmission priority determined.

Next, a process (hereinafter, also referred to as a transmission control process) for controlling data transmission in this embodiment will be described.

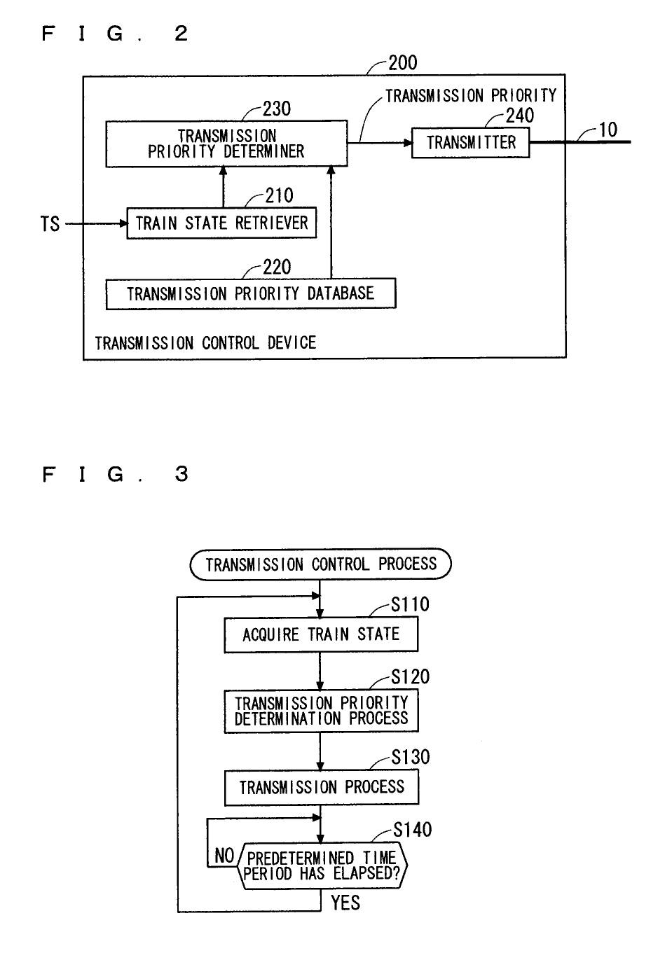

FIG. 3 is a flowchart showing the transmission control process.

In step S110, the train state retriever 210 acquires the state of the train 100, though a detailed description thereof will be given later. The train state retriever 210 transmits the acquired state of the train 100 to the transmission priority determiner 230.

In this embodiment, the train state retriever 210 acquires the speed TS of the train 100 as the state of the train 100. An example of the transmission data of this embodiment is data indicating the number of wheel rotations of the train 100.

The train 100 includes a speed manager (not shown) that manages the speed TS of the train 100. In this case, the train state retriever 210 acquires the speed TS from the speed manager (not shown) that manages the speed TS of the train 100. The train state retriever 210 transmits the acquired speed TS to the transmission priority determiner 230.

In step S120, a transmission priority determination process is performed. In the transmission priority determination process, the transmission priority determiner 230 determines the transmission priority by using the transmission priority database 220 and the acquired state of the train 100, though a detailed description thereof will be given later.

Here, a case is assumed where the transmission priority database 220 is a transmission priority database shown in FIG. 4 as an example, and the acquired state of the train 100 is the speed TS.

The transmission priority database shown in FIG. 4 indicates that the transmission priority is “LOW” when the speed TS of the train 100 is a high speed (50 Km/h or more). The transmission priority database shown in FIG. 4 indicates that the transmission priority is “HIGH” when the speed TS of the train 100 is a low speed (less than 50 Km/h).

In the transmission priority determination process of this embodiment, the transmission priority determiner 230 determines, as the transmission priority to be used by the transmitter 240, the transmission priority that is associated with the acquired state (speed TS) of the train 100 in the transmission priority database 220.

For example, when the acquired speed TS is 60 Km/h (high speed), the transmission priority determiner 230 determines that the transmission priority is “LOW”. For example, when the acquired speed TS is 20 Km/h (low speed), the transmission priority determiner 230 determines that the transmission priority is “HIGH”.

A method for determining the transmission priority is not limited to the above-described one that uses the transmission priority database. In a possible example, the transmission priority determiner 230 may determine a higher transmission priority as the acquired speed TS of the train 100 is lower.

The degree of transmission priority is not limited two levels of “LOW” and “HIGH”, but may be expressed by three or more values (For example, 1 to 5).

In step S130, a transmission process is performed. In the transmission process, the transmitter 240 changes the cycle of transmission of the transmission data in accordance with the transmission priority determined. To be specific, as the determined transmission priority is higher, the transmitter 240 sets a shorter cycle as the cycle of transmission of the transmission data.

More specifically, when the transmission priority is “HIGH”, the transmitter 240 transmits the transmission data to the transmission path 10 for every short cycle (e.g., 10 milliseconds). That is, when the transmission priority is “HIGH”, the transmitter 240 transmits the transmission data to the transmission path 10 at a high frequency. In this case, an increased number of pieces of the transmission data can be correctly transmitted to the transmission path 10.

The transmitter 240 may be configured such that, as the determined transmission priority is higher, transmission data corresponding to this transmission priority is preferentially transmitted to the transmission path 10 over other data.

When the transmission priority is “LOW”, the transmitter 240 transmits the transmission data to the transmission path 10 for every long cycle (e.g., 100 milliseconds). That is, when the transmission priority is “LOW”, the transmitter 240 transmits the transmission data to the transmission path 10 at a low frequency.

A method for changing the cycle of transmission of transmission data is not limited to the above-described one. In a possible example, when the determined transmission priority is equal to or greater than a predetermined value, the transmitter 240 may shorten the cycle of transmission of the transmission data.

In step S140, the train state retriever 210 determines whether or not a predetermined time period has elapsed since the latest processing of step S110 was started. The predetermined time period is, for example, one second. When the determination result of step S140 is YES, the processing of step S110 is performed again. When the determination result of the step S140 is NO, the processing of step S140 is performed again.

In the transmission control process according to this embodiment described above, acquisition of the state of the train 100, determination of the transmission priority, and the transmission process are performed each time the predetermined time period elapses. This achieves a transmission control for controlling transmission of transmission data in accordance with the state of a train which changes over time.

The state of the train 100 acquired is the speed of the train 100. In this embodiment, the cycle of transmission of the transmission data is changed in accordance with the transmission priority that varies depending on the speed of travelling of the train 100. Accordingly, a transmission control for controlling transmission of transmission data with a high accuracy is achieved.

For measuring the position where the train 100 is travelling, the train 100 acquires the number of wheel rotations in every constant cycle. For measuring a correct train position of the train 100, the number of wheel rotations is transmitted via the transmission path 10 from a rear part of a formation of the train 100, in which an influence of slipping and skidding is large, toward a front part of the formation, in which the position measurement is performed.

In the transmission control process according to this embodiment, for example, in a case where the speed TS of the train 100 is a low speed during a period immediately before the train 100 stops a station, the transmitter 240 transmits the transmission data to the transmission path 10 at a high frequency. That is, when the speed TS of the train 100 is a low speed, the train 100 acquires the number of wheel rotations (transmission data) at a high frequency. This can improve the accuracy of stopping of the train 100.

In the Relevant Technique A, it is difficult to suppress a delay in transmission merely by setting the transmission order, because an increase in the number of pieces of transmitted control information leads to an increase in the transmission volume. Although it is conceivable to replace the transmission path with a transmission path adapted for a large transmission volume and then set the transmission order to thereby suppress a delay in transmission, it results in an increase in the cost.

In the configuration of this embodiment, on the other hand, the transmission control for controlling transmission of transmission data with a high accuracy is achieved. Thus, it is not necessary to replace the transmission path with a transmission path adapted for a large transmission volume. Therefore, the configuration of this embodiment achieves the transmission control for controlling transmission of transmission data in accordance with the train state which varies over time, without causing a cost of replacement of the transmission path with a transmission path adapted for a large transmission volume.

The transmission process of step S130 is not limited to the process of changing the cycle of transmission of the transmission data in accordance with the transmission priority. For example, in the transmission process, it may be acceptable that the transmitter 240 makes a plurality of copies of transmission data in each cycle of transmission of transmission data in accordance with the determined transmission priority, and transmits the plurality of copies of transmission data to the transmission path 10.

To be specific, as the transmission priority is higher, the transmitter 240 may make a larger number of copies of transmission data in each cycle of transmission of transmission data, and may transmit the plurality of copies of transmission data to the transmission path 10. In another example, when the transmission priority is “HIGH”, the transmitter 240 may make a plurality of copies of transmission data in each cycle of transmission of transmission data, and may transmit the plurality of copies of transmission data to the transmission path 10. As a result, an increased number of pieces of transmission data can be correctly transmitted to the transmission path 10. Thus, the transmission control for controlling transmission of transmission data can be performed with a high accuracy.

<Modification of Embodiment 1>

In the embodiment 1, the speed of the train is adopted as the state of the train. In a modification of this embodiment, the position of the train is adopted.

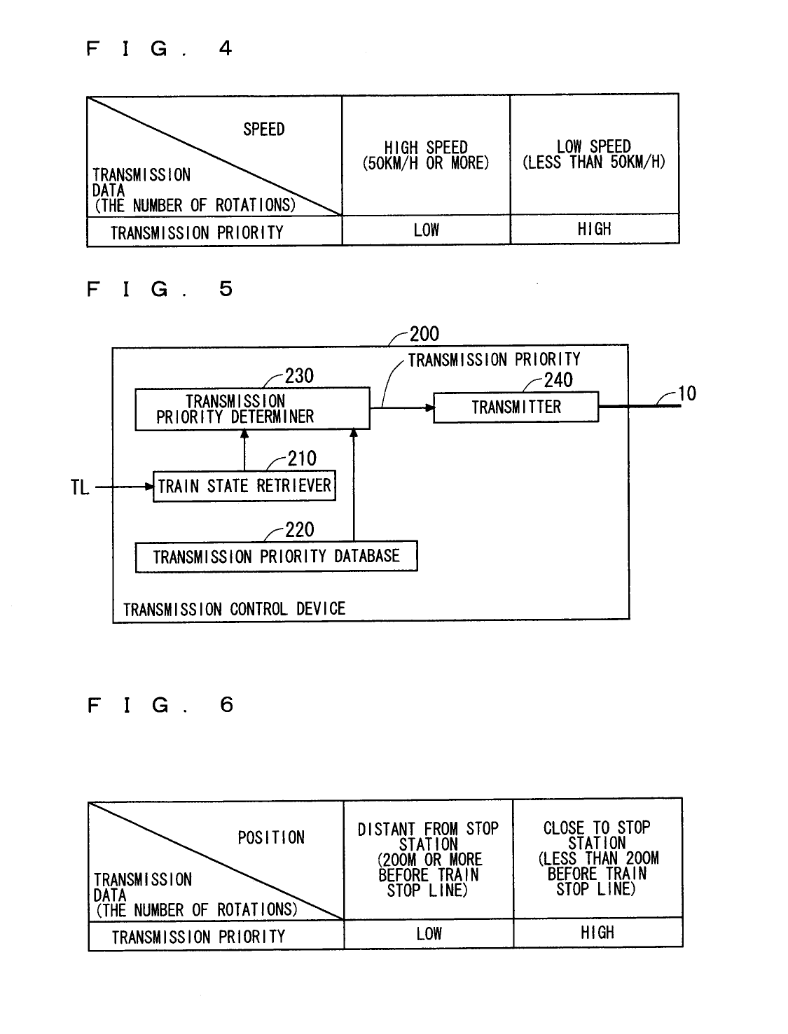

As shown in FIG. 5, a transmission control device 200 according to a modification of this embodiment has the same configuration as the configuration of the transmission control device 200 shown in FIG. 2, and therefore details of the transmission control device 200 are not repeatedly described here.

The transmission control device 200 according to the modification of this embodiment acquires a position TL as the state of the train 100. The position TL indicates the position of the head of the train 100. The position TL is expressed by, for example, the latitude and longitude. The position TL is not limited to the position of the head of the train 100, and it may be the position of the center of the train 100, for example.

Next, a transmission control process for controlling data transmission in the modification of this embodiment will be described. In the following, among the processing of a transmission control process according to the modification of this embodiment, processing that is different from the embodiment 1 will be mainly described.

Referring to FIG. 3, in step S110, the train state retriever 210 acquires the position TL of the train 100 as the state of the train 100. In the modification of this embodiment, similarly to the embodiment 1, transmission data is data indicating the number of wheel rotations of the train 100.

In the modification of this embodiment, the state of the train 100 is, for example, a state where the position of the train 100 is 200 m or more before a train stop line provided in a stop station. Here, the stop station means a station at which the train 100 is scheduled to stop. That is, the state of the train 100 is expressed by the position of the train 100.

As described above, the train 100 acquires the number of wheel rotations in every constant cycle, and thereby measures the traveling position (position TL) of the train 100. In this case, the train state retriever 210 acquires the position TL from the train 100. The train state retriever 210 transmits the acquired position TL to the transmission priority determiner 230.

In the transmission priority determination process of step S120, the transmission priority determiner 230 determines the transmission priority by using the transmission priority database 220 and the acquired state (position TL) of the train 100.

Here, a case is assumed where the transmission priority database 220 is a transmission priority database shown in FIG. 6 as an example, and the acquired state of the train 100 is the position TL.

The transmission priority database shown in FIG. 6 indicates that the transmission priority is “LOW” when the position TL of the train 100 represents a position distant from the stop station. To be specific, for example, when the position TL represents a position 200m or more before the train stop line provided in the stop station, the position of the train 100 is a position distant from the stop station.

The transmission priority database shown in FIG. 6 indicates that the transmission priority is “HIGH” when the position TL of the train 100 represents a position close to the stop station. To be specific, for example, when the position TL represents a position less than 200 m before the train stop line provided in the stop station, the position of the train 100 is a position close to the stop station.

In the transmission priority determination process according to the modification of this embodiment, the transmission priority determiner 230 determines, as the transmission priority to be used by the transmitter 240, the transmission priority that is associated with the acquired state (position TL) of the train 100 in the transmission priority database 220.

For example, when the position TL represents a position distant from the stop station, the transmission priority determiner 230 determines that the transmission priority is “LOW”. For example, when the position TL represents a position close to the stop station, the transmission priority determiner 230 determines that the transmission priority is “HIGH”.

A method for determining the transmission priority is not limited to the above-described one that uses the transmission priority database. In a possible example, the transmission priority determiner 230 may determine a higher transmission priority as the acquired position TL of the train 100 is closer to a station (stop station) at which the train 100 is scheduled to stop.

Then, the processing of steps S130 and S140 are performed in the same manner as in the embodiment 1.

In the transmission control process according to the modification of this embodiment thus far described, acquisition of the state of the train 100, determination of the transmission priority, and the transmission process are performed each time the predetermined time period elapses. This achieves a transmission control for controlling transmission of transmission data in accordance with the state of a train which changes over time.

The state of the train 100 acquired is the position of the train 100. Therefore, in the modification of this embodiment, the cycle of transmission of the transmission data is changed in accordance with the transmission priority that varies depending on the position of the train 100. Accordingly, as compared with the conventional technique in which the degree of priority of transmission is fixed, a transmission control for controlling transmission of transmission data suitably for the state of the train 100 with a high accuracy is achieved.

In the modification of this embodiment, when the position TL of the train 100 represents a position close to the stop station, that is, when the speed TS of the train 100 is a low speed, the train 100 acquires the number of wheel rotations (transmission data) at a high frequency. This can improve the accuracy of stopping of the train 100.

In the transmission process of step S130, similarly to the embodiment 1, it may be acceptable that the transmitter 240 makes a plurality of copies of transmission data in each cycle of transmission of transmission data in accordance with the determined transmission priority, and transmits the plurality of copies of transmission data to the transmission path 10. As a result, an increased number of pieces of transmission data can be correctly transmitted to the transmission path 10. Thus, the transmission control for controlling transmission of transmission data can be performed with a high accuracy.

### Embodiment 2

In the embodiment 1, the speed of the train is adopted as the state of the train. In this embodiment, the rate of transmission error which will be described later is adopted.

FIG. 7 is a block diagram showing a configuration of a transmission control device 200A according to an embodiment 2. The train 100 according to this embodiment is provided with a transmission control device 200A instead of the transmission control device 200 of FIG. 1.

Referring to FIG. 7, the transmission control device 200A is different from the transmission control device 200 of FIG. 1, in that a transmitter 240A is provided instead of the transmitter 240. The other parts of the configuration of the transmission control device 200A are the same as those of the transmission control device 200, and therefore details thereof are not repeatedly described here.

Similarly to the transmitter 240, the transmitter 240A transmits the transmission data to the transmission path 10 in accordance with the transmission priority determined by the transmission priority determiner 230. The transmitter 240A includes a transmission error rate monitor 241 that monitors the rate of transmission error. Here, the rate of transmission error means the probability of occurrence of a transmission error in transmitting transmission data of the same type to the transmission path 10. In this embodiment, for example, the state of the train 100 is a communication state of the transmission path 10 (train 100), that is expressed as the rate of transmission error.

The transmission error rate monitor 241 monitors transmission data that is transmitted through the transmission path 10.

The transmission data includes a check code for calculation of the rate of transmission error. The transmission error rate monitor 241 detects as needed a check code included in the transmission data that is transmitted through the transmission path 10. Each time a predetermined time period elapses, the transmission error rate monitor 241 calculates the rate of transmission error in transmitting the transmission data that is transmitted through the transmission path 10. The calculation is made with respect to each type of the transmission data.

For example, in a case where the transmission data is control data or data indicating the number of rotations, the transmission error rate monitor 241 calculates the rate of transmission error with respect to each transmission data indicating the control data, and additionally calculates the rate of transmission error with respect to each transmission data indicating the number of rotations. The rate of transmission error is calculated based on the following Formula 1.

The number E of transmission errors/the number N of pieces of transmission data per unit time (Formula 1)

In Formula 1, the number N of pieces of transmission data per unit time means the number of pieces of transmission data of the same type that is scheduled to be transmitted through the transmission path 10 during the unit time. The number E of transmission errors means the value obtained by subtracting, from the number N, the number of check codes included in the pieces of transmission data of the same type that have been detected by the transmission error rate monitor 241 during the unit time.

The above-described method for calculating the rate of transmission error is merely an illustrative example, and the calculation may be implemented through other methods.

Next, a transmission control process for controlling data transmission according to this embodiment will be described. In the following, among the processing of a transmission control process according to this embodiment, processing that is different from the embodiment 1 will be mainly described. This embodiment is based on the assumption that the number of types of transmission data is two. The number of types of transmission data is not limited to two, and may be three or more.

Referring to FIG. 3, in step S110, the train state retriever 210 acquires, from the transmission error rate monitor 241, the latest rate of transmission error as the state of the train 100. More specifically, the train state retriever 210 acquires, from the transmission error rate monitor 241, a plurality of rates of transmission error, each corresponding to each of a plurality of types of transmission data. In a case where the number of types of transmission data is two, as an example, the train state retriever 210 acquires two rates of transmission error each corresponding to each of the two types of transmission data.

Then, the train state retriever 210 sequences the acquired two rates of transmission error in descending order of the value. Then, the train state retriever 210 transmits the two rates of transmission error thus sequenced, to the transmission priority determiner 230.

In the transmission priority determination process of step S120, the transmission priority determiner 230 determines the transmission priority by using the transmission priority database 220 and the acquired state (the rate of transmission error) of the train 100.

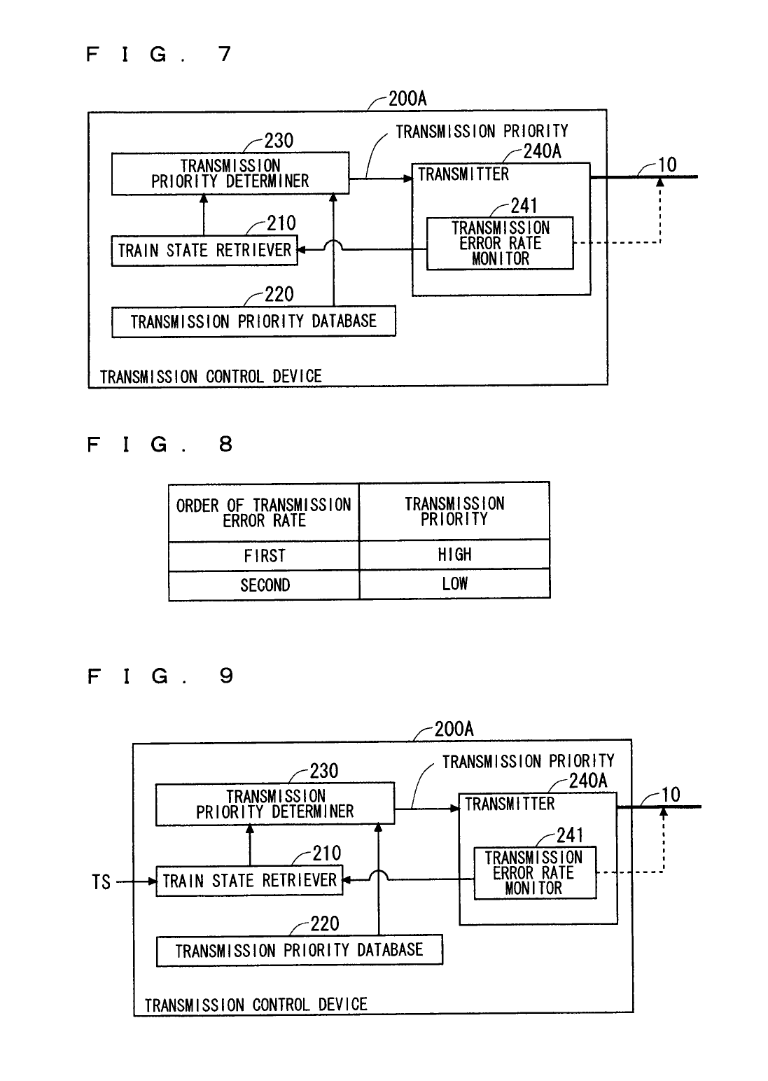

Here, a case is assumed where the transmission priority database 220 is a transmission priority database shown in FIG. 8 as an example, and the acquired state of the train 100 is the two sequenced rates of transmission error.

The transmission priority database shown in FIG. 8 indicates that the transmission priority of transmission data associated with a first rate of transmission error is “HIGH”. The first rate of transmission error means the largest rate of transmission error among the two rates of transmission error acquired by the transmission priority determiner 230.

The transmission priority database shown in FIG. 8 indicates that the transmission priority of transmission data associated with a second rate of transmission error is “LOW”. The second rate of transmission error means the second largest rate of transmission error among the two rates of transmission error acquired by the transmission priority determiner 230.

In the transmission priority determination process of this embodiment, the transmission priority determiner 230 determines the transmission priority based on the acquired state (the rate of transmission error) of the train.

For example, the transmission priority determiner 230 determines that the transmission priority of transmission data associated with the first rate of transmission error is “HIGH”, in accordance with the transmission priority database shown in FIG. 8. The transmission priority determiner 230 determines that the transmission priority of transmission data associated with the second rate of transmission error is “LOW”, in accordance with the transmission priority database shown in FIG. 8.

Then, similarly to the embodiment 1, the processing of steps S130 and S140 are performed.

In the transmission control process according to this embodiment described above, acquisition of the state of the train 100, determination of the transmission priority, and the transmission process are performed each time the predetermined time period elapses. This achieves a transmission control for controlling transmission of transmission data in accordance with the state of a train which changes over time.

The state of the train 100 acquired is the communication state (the rate of transmission error) of the train 100. The communication state (the rate of transmission error) of the train 100 means a state of data transmission in the transmission path 10. Therefore, in this embodiment, the cycle of transmission of the transmission data is changed in accordance with the transmission priority that varies depending on the rate of transmission error in the train 100. Accordingly, as compared with the conventional technique in which the degree of priority of transmission is fixed, a transmission control for controlling transmission of transmission data suitably for the state of the train 100 with a high accuracy is achieved.

In the transmission process of step S130, similarly to the embodiment 1, it may be acceptable that the transmitter 240A makes a plurality of copies of transmission data in each cycle of transmission of transmission data in accordance with the determined transmission priority, and transmits the plurality of copies of transmission data to the transmission path 10. As a result, an increased number of pieces of transmission data can be correctly transmitted to the transmission path 10. Thus, the transmission control for controlling transmission of transmission data can be performed with a high accuracy.

In this embodiment, a plurality of rates of transmission error are sequenced. However, the sequencing may not necessarily be made. In such a case, the train state retriever 210 transmits the acquired two rates of transmission error to the transmission priority determiner 230. Then, the transmission priority determiner 230 determines the transmission priority by using the received two rates of transmission error.

### Embodiment 3

In the embodiment 1, the speed of the train is adopted as the state of the train. In this embodiment, not only the speed of the train but also the rate of transmission error is adopted.

Referring to FIG. 9, a transmission control device 200A according to this embodiment has the same configuration as the configuration of the transmission control device 200A shown in FIG. 7, and therefore details of the transmission control device 200A are not repeatedly described here.

Similarly to the embodiment 1, the transmission control device 200A according to this embodiment acquires the speed TS of the train 100 as the state of the train 100. Similarly to the embodiment 2, a transmission error rate monitor 241 of the transmission control device 200A according to this embodiment monitors transmission data that is transmitted through the transmission path 10. In one example, the transmission data of this embodiment is data indicating the number of wheel rotations of the train 100.

The transmission error rate monitor 241 calculates the rate of transmission error, in the same manner as in the embodiment 2. That is, the rate of transmission error calculated by the transmission error rate monitor 241 is the rate of transmission error in transmitting the transmission data indicating the number of wheel rotations.

Next, a process (hereinafter, also referred to as a transmission control process A) for controlling data transmission according to this embodiment will be described.

FIG. 14 is a flowchart showing the transmission control process A. In FIG. 14, the processing given the same step number as the step number given on FIG. 3 is the same processing as the processing described in the embodiment 1, and therefore details thereof are not repeatedly described here. The transmission control process A is different from the transmission control process shown in FIG. 1, in that step S110A is performed instead of step S110 and that step S120A is performed instead of step S120.

In the following, points different from the embodiment 1 or the embodiment 2 will be mainly described.

In step S110A, similarly to the embodiment 1, the train state retriever 210 acquires the speed TS of the train 100 as the state of the train 100. Then, the train state retriever 210 transmits the acquired speed TS to the transmission priority determiner 230.

Additionally, similarly to the embodiment 2, the train state retriever 210 acquires, from the transmission error rate monitor 241, the latest rate of transmission error as the state of the train 100. Then, the train state retriever 210 transmits the acquired latest rate of transmission error to the transmission priority determiner 230.

In step S120A, the transmission priority determination process A is performed. In the transmission priority determination process A, the transmission priority determiner 230 tentatively determines the transmission priority by using the transmission priority database 220 and the acquired state (speed TS) of the train 100. A method for tentatively determining the transmission priority is similar to the method for determining the transmission priority described in the embodiment 1.

Here, a case is assumed where the transmission priority database 220 is a transmission priority database shown in FIG. 4 as an example.

For example, when the speed TS is 60 Km/h (high speed), the transmission priority determiner 230 tentatively determines that the transmission priority is “LOW”. For example, when the speed TS is 20 Km/h (low speed), the transmission priority determiner 230 tentatively determines that the transmission priority is “HIGH”.

Then, in a case where, under the condition that the transmission priority determiner 230 has tentatively determined that the transmission priority is “LOW”, the acquired latest rate of transmission error is equal to or greater than a predetermined threshold value; the transmission priority determiner 230 conclusively determines that the transmission priority is “HIGH”. The predetermined threshold value is, for example, 30%.

In a case where, under the condition that the transmission priority determiner 230 has tentatively determined that the transmission priority is “HIGH”, the acquired latest rate of transmission error is equal to or greater than the predetermined threshold value; the transmission priority determiner 230 conclusively determines that the transmission priority is “HIGHEST” which is higher than “HIGH”.

In a case where the acquired latest rate of transmission error is less than the predetermined threshold value, the transmission priority determiner 230 determines that the transmission priority that has been tentatively determined is a conclusive transmission priority.

A method for determining the transmission priority is not limited to the above-described one that uses the transmission priority database. In a possible example, the transmission priority determiner 230 may determine a higher transmission priority as the acquired rate of transmission error is higher.

Then, similarly to the embodiment 1, the processing of steps S130 and S140 are performed.

In the transmission control process A according to this embodiment described above, acquisition of the state of the train 100, tentative determination of the transmission priority, conclusive determination of the transmission priority, and the transmission process are performed each time the predetermined time period elapses. This achieves a transmission control for controlling transmission of transmission data in accordance with the state of a train which changes over time.

To be specific, in this embodiment, two elements, namely, the speed TS and the rate of transmission error, are used for conclusive determination of the transmission priority. This can determine the transmission priority at a high accuracy in accordance with the speed of the train and the rate of transmission error that vary over time. Using the position TL instead of the speed TS is also acceptable in this embodiment.

In this embodiment, the cycle of transmission of transmission data is changed by using the transmission priority that has been determined at such a high accuracy. Thus, in this embodiment, the transmission priority that varies depending on the speed of traveling (speed TS) of the train 100 is reflected into transmission of transmission data, and additionally the transmission priority that has been determined in consideration of the transmission state (communicate state) of the train 100 is reflected into transmission of transmission data. Accordingly, as compared with the conventional technique in which the degree of priority of transmission is fixed, a transmission control for controlling transmission of transmission data suitably for the state of the train 100 with a high accuracy is achieved.

In the transmission process of step S130, similarly to the embodiment 1, it may be acceptable that the transmitter 240A makes a plurality of copies of transmission data in each cycle of transmission of transmission data in accordance with the determined transmission priority, and transmits the plurality of copies of transmission data to the transmission path 10. As a result, an increased number of pieces of transmission data can be correctly transmitted to the transmission path 10. Thus, the transmission control for controlling transmission of transmission data can be performed with a high accuracy.

### Embodiment 4

In the embodiment 1, the speed of the train is adopted as the state of the train. In this embodiment, a power running command of the train is adopted. The power running command means a command for acceleration.

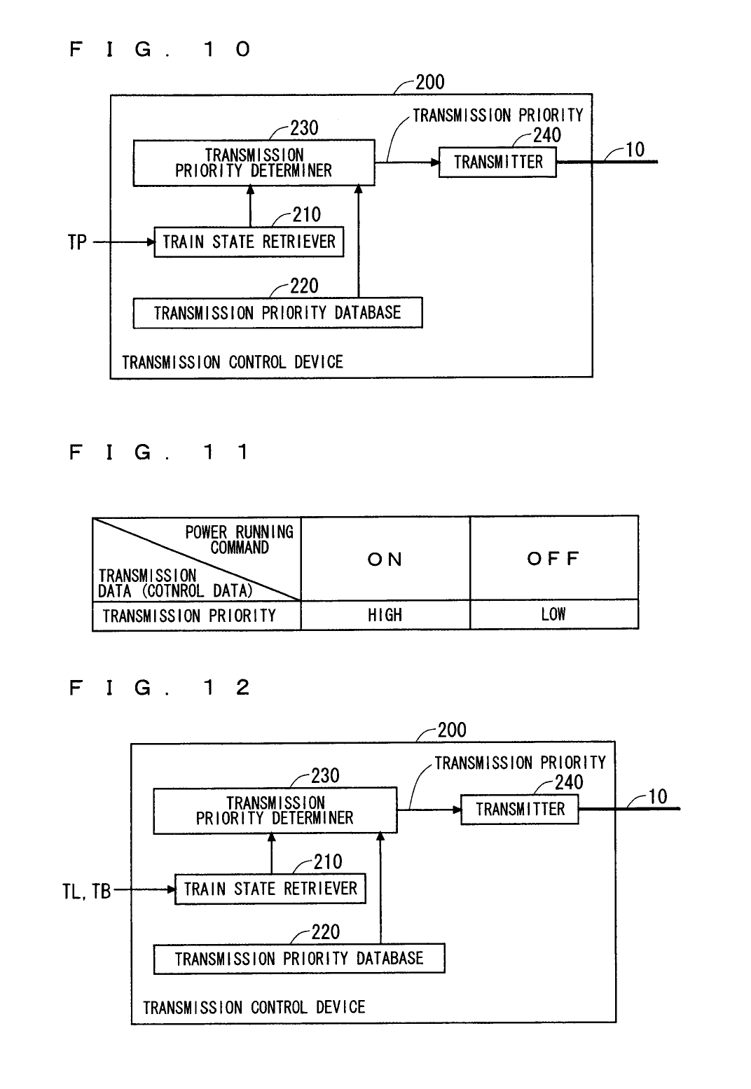

As shown in FIG. 10, a transmission control device 200 according to this embodiment has the same configuration as the configuration of the transmission control device 200 shown in FIG. 2, and therefore details of the transmission control device 200 are not repeatedly described here.

The transmission control device 200 according to this embodiment acquires a power running command TP as the state of the train 100.

Next, a transmission control process for controlling data transmission according to this embodiment will be described. In the following, among the processing of a transmission control process according to this embodiment, processing that is different from the embodiment 1 will be mainly described.

Referring to FIG. 3, in step S110, the train state retriever 210 acquires the power running command TP of the train 100 as the state of the train 100. In one example, the transmission data of this embodiment is control data or data indicating the number of wheel rotations.

In this embodiment, the state of the train 100 is a state where the power running command is outputted in order to accelerate the train 100. In this case, the train state retriever 210 acquires the power running command TP from the train 100. Then, the train state retriever 210 transmits the acquired power running command TP to the transmission priority determiner 230.

In the transmission priority determination process of step S120, the transmission priority determiner 230 determines the transmission priority by using the transmission priority database 220 and the acquired state (power running command TP) of the train 100.

Here, a case is assumed where the transmission priority database 220 is a transmission priority database shown in FIG. 11 as an example, and the acquired state of the train 100 is the power running command TP.

When the train 100 accelerates, the number of rotations of a motor increases in accordance with the state of the train (power running command TP). At this time, noise caused from the motor increases, which increases the rate of transmission error occurring in the transmission path 10. In this respect, for example, the priority database shown in FIG. 11 indicates that the transmission priority is “HIGH” when the acquired power running command TP is ON. The priority database shown in FIG. 11 indicates that the transmission priority is “LOW” when the power running command TP is OFF.

In the transmission priority determination process according to this embodiment, the transmission priority determiner 230 determines, as the transmission priority to be used by the transmitter 240, the transmission priority that is associated with the acquired state (power running command TP) of the train 100 in the transmission priority database 220.

For example, when the power running command TP is ON, the transmission priority determiner 230 determines that the transmission priority is “HIGH”. For example, when the power running command TP is OFF, the transmission priority determiner 230 determines that the transmission priority is “LOW”.

A method for determining the transmission priority is not limited to the above-described one that uses the transmission priority database. In a possible example, the transmission priority determiner 230 may determine a higher transmission priority as the notch of the acquired power running command TP for the train 100 is larger.

Then, similarly to the embodiment 1, the processing of steps S130 and S140 are performed.

In the transmission control process according to this embodiment described above, acquisition of the state of the train 100, determination of the transmission priority, and the transmission process are performed each time the predetermined time period elapses. This achieves a transmission control for controlling transmission of transmission data in accordance with the state of a train which changes over time.

The state of the train 100 acquired is the power running command of the train 100. Therefore, in this embodiment, the cycle of transmission of the transmission data is changed in accordance with the transmission priority that varies depending on the power running command of the train 100. Accordingly, as compared with the conventional technique in which the degree of priority of transmission is fixed, a transmission control for controlling transmission of transmission data suitably for the state of the train 100 with a high accuracy is achieved.

In the transmission process of step S130, similarly to the embodiment 1, it may be acceptable that the transmitter 240 makes a plurality of copies of transmission data in each cycle of transmission of transmission data in accordance with the determined transmission priority, and transmits the plurality of copies of transmission data to the transmission path 10. As a result, an increased number of pieces of transmission data can be correctly transmitted to the transmission path 10. Thus, the transmission control for controlling transmission of transmission data can be performed with a high accuracy.

### Embodiment 5

In the embodiment 1, the speed of the train is adopted as the state of the train. In this embodiment, a brake command that is for stopping the train at a station is adopted.

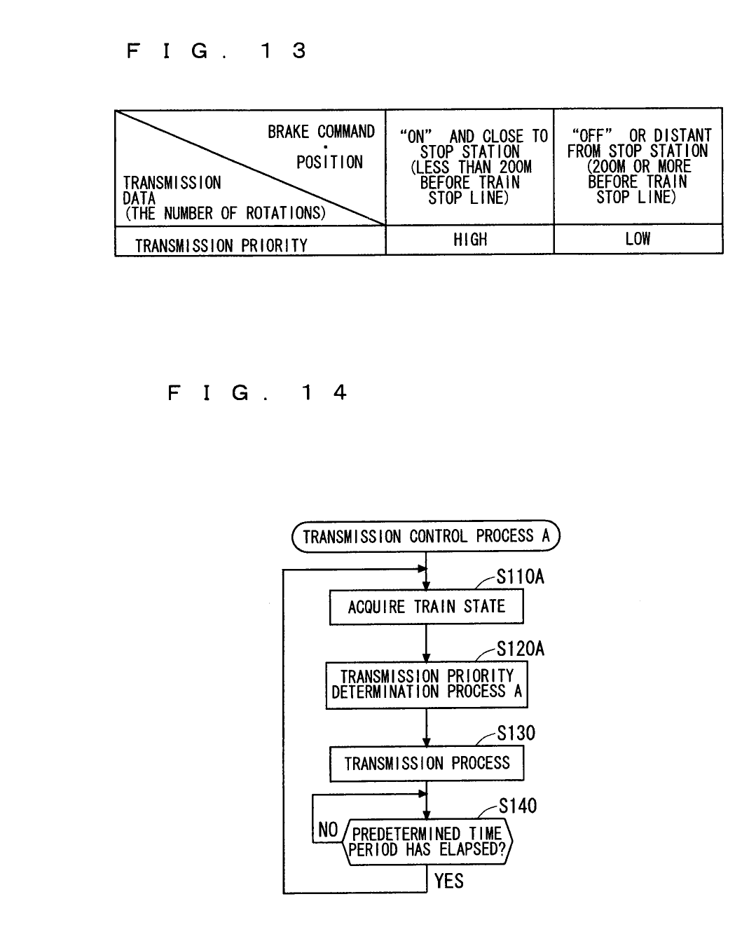

As shown in FIG. 12, a transmission control device 200 according to this embodiment has the same configuration as the configuration of the transmission control device 200 shown in FIG. 2, and therefore details of the transmission control device 200 are not repeatedly described here.

The transmission control device 200 according to this embodiment acquires the position TL and a brake command TB as the state of the train 100.

Next, a transmission control process for controlling data transmission according to this embodiment will be described. In the following, among the processing of a transmission control process according to this embodiment, processing that is different from the embodiment 1 will be mainly described.

Referring to FIG. 3, in step S110, the train state retriever 210 acquires the position TL and the brake command TB of the train 100 as the state of the train 100. In one example, the transmission data of this embodiment is data indicating the number of wheel rotations.

In this embodiment, the state of the train 100 is a state where the brake command is outputted in order that the train 100 stops at the station. In this case, the train state retriever 210 acquires the position TL and the brake command TB from the train 100. Then, the train state retriever 210 transmits the acquired position TL and brake command TB to the transmission priority determiner 230.

In the transmission priority determination process of step S120, the transmission priority determiner 230 determines the transmission priority by using the transmission priority database 220 and the acquired state (position TL and brake command TB) of the train 100.

Here, a case is assumed where the transmission priority database 220 is a transmission priority database shown in FIG. 13 as an example, and the acquired state of the train 100 is the position TL and the brake command TB.

The transmission priority database shown in FIG. 13 indicates that the transmission priority is “HIGH” when the position TL of the train 100 is a position close to the stop station and additionally the brake command TB is ON. To be specific, the transmission priority is “HIGH” when, for example, the position TL represents a position less than 200 m before the train stop line provided in the stop station and additionally the brake command TB is ON.

The transmission priority database shown in FIG. 13 indicates that the transmission priority is “LOW” when the position TL of the train 100 represents a position distant from the stop station or when the brake command TB is OFF. To be specific, the transmission priority is “LOW” when, for example, the position TL represents a position 200m or more before the train stop line provided in the stop station or when the brake command TB is OFF.

In the transmission priority determination process of this embodiment, the transmission priority determiner 230 determines, as the transmission priority to be used by the transmitter 240, the transmission priority that is associated with the acquired state (position TL and brake command TB) of the train 100 in the transmission priority database 220.

For example, when the position TL represents a position close to the stop station and additionally the brake command TB is ON, the transmission priority determiner 230 determines that the transmission priority is “HIGH”. For example, when the position TL represents a position distant from the stop station or when the brake command TB is OFF, the transmission priority determiner 230 determines that the transmission priority is “LOW”.

A method for determining the transmission priority is not limited to the above-described one that uses the transmission priority database. In a possible example, the transmission priority determiner 230 may determine a higher transmission priority as the position TL is closer to a station (stop station) at which the train 100 is scheduled to stop under the condition that the acquired brake command TB of the train 100 is ON.

Then, similarly to the embodiment 1, the processing of steps S130 and S140 are performed.

In the transmission control process according to this embodiment described above, acquisition of the state of the train 100, determination of the transmission priority, and the transmission process are performed each time the predetermined time period elapses. This achieves a transmission control for controlling transmission of transmission data in accordance with the state of a train which changes over time.

The state of the train 100 acquired is the position TL and the brake command TB of the train 100. Therefore, in this embodiment, the cycle of transmission of the transmission data is changed in accordance with the transmission priority that varies depending on the position TL and the brake command TB of the train 100. Accordingly, as compared with the conventional technique in which the degree of priority of transmission is fixed, a transmission control for controlling transmission of transmission data suitably for the state of the train 100 with a high accuracy is achieved.

In this embodiment, when the position TL of the train 100 represents a position close to the stop station and additionally the brake command TB that is for stopping the train is ON, the train 100 acquires the number of wheel rotations (transmission data) at a high frequency. This can improve the accuracy of stopping of the train 100.

In the transmission process of step S130, similarly to the embodiment 1, it may be acceptable that the transmitter 240 makes a plurality of copies of transmission data in each cycle of transmission of transmission data in accordance with the determined transmission priority, and transmits the plurality of copies of transmission data to the transmission path 10. As a result, an increased number of pieces of transmission data can be correctly transmitted to the transmission path 10. Thus, the transmission control for controlling transmission of transmission data can be performed with a high accuracy.

(Other Modifications)

Although the transmission control device according to the present invention has been described based on some embodiments illustrated above, the present invention is not limited to these embodiments. Without departing from the spirit of the present invention, variations and modifications of these embodiments that can be conceived by those skilled in the art are included in the present invention. That is, the embodiments of the present invention can be varied, modified, or omitted as appropriate within the scope of the invention.

For example, the configurations of the transmission control device 200 and the transmission control device 200A are merely illustrative, and not limited to the above-described ones. Therefore, the transmission control device 200 or the transmission control device 200A may not necessarily include all of the above-mentioned components. In other words, it suffices that the transmission control device 200 or the transmission control device 200A includes only minimum components required for achievement of the advantageous effects of the present invention.

In an exemplary configuration, the rules described in the transmission priority database 220 are preliminarily stored in the transmission priority determiner 230. In this configuration, the transmission control device 200 and the transmission control device 200A need not include the transmission priority database 220.

The processing performed by the train state retriever 210, the transmission priority determiner 230, and the transmitter 240 of the above-described embodiments is merely illustrative, and not limited to the above-described one. The transmission priority database 220 of the above-described embodiment is merely illustrative, and not limited to the above-described one.

The present invention may be also embodied as a transmission control method including steps performed by the characteristic elements of the transmission control device 200 or the transmission control device 200A. The present invention may be also embodied as a program that causes a computer to perform the steps included in such a transmission control method. The present invention may be also embodied as a computer-readable recording medium having such a program stored therein. The program may be distributed via a transmission medium such as Internet.

All of the values adopted in the above-described embodiments are taken as an example for giving a specific description of the present invention. Therefore, in the present invention, values are not limited to the values adopted in the above-described embodiments.

The transmission control method according to the present invention corresponds to the transmission control process shown in FIG. 3 or the transmission control process A shown in FIG. 14. It may not be always necessary that the transmission control method according to the present invention includes all the corresponding steps shown in FIG. 3 or FIG. 14. It suffices that the transmission control method according to the present invention includes only minimum steps required for achievement of the advantageous effects of the present invention.

The sequence in which the steps of the transmission control method are performed is taken as an example for giving a specific description of the present invention. Therefore, a sequence different from the above-described one is also adoptable. Moreover, some part and other part of the steps of the transmission control method may be performed independently and concurrently.

Some of the components included in the transmission control device 200 or the transmission control device 200A may be implemented as an LSI (Large Scale Integration), which typically is an integrated circuit. For example, the train state retriever 210, the transmission priority determiner 230, and the transmitter 240 may be implemented as an integrated circuit.

In the present invention, one embodiment may be freely combined with another embodiment, and the embodiments may be appropriately varied, modified, or omitted.

While the invention has been described in detail, the foregoing description is in all aspects illustrative and not restrictive. It is therefore understood that numerous modifications and variations not illustrated herein can be devised without departing from the scope of the invention.

### INDUSTRIAL APPLICABILITY

The present invention is applicable as a transmission control device that achieves a transmission control for controlling transmission of transmission data in accordance with the state of a train.

### DESCRIPTION OF THE REFERENCE NUMERALS

10 transmission path; 100 train; 200, 200A transmission control device; 210 train state retriever; 220 transmission priority database; 230 transmission priority determiner; 240, 240A transmitter; 241 transmission error rate monitor

1. A transmission control device configured to transmit data within a train by using a transmission path provided in said train, said transmission control device comprising:
a train state retriever that acquires the speed of said train;
a transmission priority determiner that determines a higher transmission priority as the acquired speed of said train is lower, said transmission priority being the degree of priority of transmission of transmission data serving as a transmission object to said transmission path; and
a transmitter that transmits said transmission data to said transmission path in accordance with said transmission priority determined.

2-12. (canceled)

13. The transmission control device according to claim 1, wherein
as said transmission priority determined is higher, said transmitter sets a shorter cycle as a cycle of transmission of said transmission data.

14. The transmission control device according to claim 1, wherein
in accordance with said transmission priority determined, said transmitter makes a plurality of copies of said transmission data in each cycle of transmission of said transmission data, and transmits the plurality of copies of said transmission data to said transmission path.

15. A transmission control device configured to transmit data within a train by using a transmission path provided in said train, said transmission control device comprising:
a train state retriever that acquires the position of said train;
a transmission priority determiner that determines a higher transmission priority as the acquired position of said train is closer to a station at which said train is scheduled to stop, said transmission priority being the degree of priority of transmission of transmission data serving as a transmission object to said transmission path; and
a transmitter that transmits said transmission data to said transmission path in accordance with said transmission priority determined.

16. The transmission control device according to claim 15, wherein
as said transmission priority determined is higher, said transmitter sets a shorter cycle as a cycle of transmission of said transmission data.

17. The transmission control device according to claim 15, wherein
in accordance with said transmission priority determined, said transmitter makes a plurality of copies of said transmission data in each cycle of transmission of said transmission data, and transmits the plurality of copies of said transmission data to said transmission path.

18. A transmission control device configured to transmit data within a train by using a transmission path provided in said train, said transmission control device comprising:
a train state retriever that acquires the state of said train;
a transmission priority determiner that determines a transmission priority based on the acquired state of said train, said transmission priority being the degree of priority of transmission of transmission data serving as a transmission object to said transmission path; and
a transmitter that transmits said transmission data to said transmission path in accordance with said transmission priority determined,
wherein said transmitter includes a transmission error rate monitor that monitors a rate of transmission error that is the probability of occurrence of a transmission error in transmitting transmission data of the same type to said transmission path, and
said train state retriever acquires, from said transmission error rate monitor, said rate of transmission error as the state of said train.

19. The transmission control device according to claim 18, wherein
as said rate of transmission error acquired is higher, said transmission priority determined by said transmission priority determiner is higher.

20. The transmission control device according to claim 18, wherein
as said transmission priority determined is higher, said transmitter sets a shorter cycle as a cycle of transmission of said transmission data.

21. The transmission control device according to claim 18, wherein
in accordance with said transmission priority determined, said transmitter makes a plurality of copies of said transmission data in each cycle of transmission of said transmission data, and transmits the plurality of copies of said transmission data to said transmission path.
